(19) United States
(12) Patent Application Publication
(10) Pub. No.: US 2009/0066693 A1
(43) Pub. Date: Mar. 12, 2009

(54) Encoding A Depth Map Into An Image Using Analysis Of Two Consecutive Captured Frames

(76) Inventor: Roc Carson, Vancouver (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/851,170

(22) Filed: Sep. 6, 2007

(51) Int. Cl. G06T 15/40

(52) U.S. Cl. 345/422

(57) ABSTRACT

A computer implemented method of calculating and encoding depth data from captured image data is disclosed. In one operation, the computer implemented method captures two successive frames of image data through a single image capture device. In another operation, differences between a first frame of image data and a second frame of the image data are determined. In still another operation, a depth map is calculated when pixel data of the first frame of the image data is compared to pixel data of the second frame of the image data. In another operation, the depth map is encoded into a header of the first frame of image data.

### BACKGROUND OF THE INVENTION

The proliferation of digital cameras has coincided with the decrease in cost of storage media. Additionally, the decrease in size and cost of digital camera hardware allows digital cameras to be incorporated with many mobile electronic devices such as cellular telephones, wireless smart phones, and notebook computers. With the rapid and extensive proliferation, a competitive business environment as developed for digital camera hardware. In such a competitive environment it can be beneficial to include features that can distinguish a product from similar products.

Depth data can be used to enhance realism or be artificially added to photos using photo editing software. One method for capturing depth data uses specialized equipment such as stereo cameras or other specialized depth sensing cameras. Without such specialized cameras, the creation or simulation of depth data can be created using photo editing software to create a depth field in an existing photograph. The creation of a depth field can require extensive user interaction with often expensive and difficult to use photo manipulation software.

In view of the forgoing, there is a need to automatically capture depth data when taking digital photographs with relatively inexpensive digital camera hardware.

### SUMMARY

In one embodiment, a computer implemented method of calculating and encoding depth data from captured image data is disclosed. In one operation, the computer implemented method captures two successive frames of image data through a single image capture device. In another operation, differences between a first frame of image data and a second frame of the image data are determined. In still another operation, a depth map is calculated when pixel data of the first frame of the image data is compared to pixel data of the second frame of the image data. In another operation, the depth map is encoded into a header of the first frame of image data.

In another embodiment, an image capture device configured to generate a depth map from captured image data is disclosed. The image capture device can include a camera interface and an image storage controller interfaced with the camera interface. Additionally, the image storage controller can be configured to store two successive frames of image data from the camera interface. A depth mask capture module may also be included in the image capture device. The depth mask capture module can be configured to create a depth mask based on differences between two successive frames of image data. Also included in the image capture device is a depth engine configured to process the depth mask to generate a depth map identifying a depth plane for elements in the captured image.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1 is a simplified schematic diagram illustrating a high level architecture of a device for encoding a depth map into an image using analysis of two consecutive captured frames in accordance with one embodiment of the present invention.

FIG. 2 is a simplified schematic diagram illustrating a high level architecture for the graphics controller in accordance with one embodiment of the present invention.

FIG. 3A illustrates a first image captured using an MGE in accordance with one embodiment of the present invention.

FIG. 3B illustrates a second image 300′ that was also captured using an MGE in accordance with one embodiment of the present invention.

FIG. 3C illustrates the shift of the image elements by overlying the second image over the first image in accordance with one embodiment of the present invention.

FIG. 4 is an exemplary flow chart of a procedure to encode a depth map in accordance with one embodiment of the present invention.

### DETAILED DESCRIPTION

An invention is disclosed for calculating and saving depth data associated with elements within a digital image. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

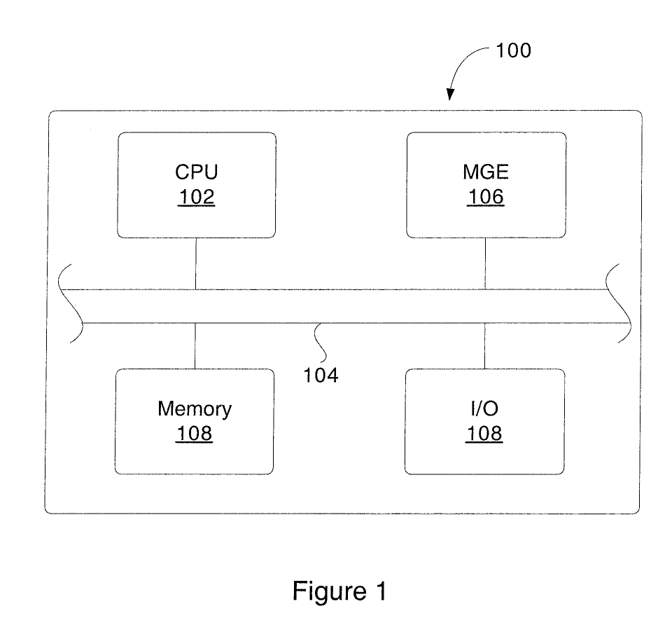

FIG. 1 is a simplified schematic diagram illustrating a high level architecture of a device 100 for encoding a depth map into an image using analysis of two consecutive captured frames in accordance with one embodiment of the present invention. The device 100 includes a processor 102, a graphics controller or Mobile Graphic Engine (MGE) 106, a memory 108, and an Input/Ouput (I/O) interface 110, all capable of communicating with each other using a bus 104.

Those skilled in the art will recognize that the I/O interface 110 allows the components illustrated in FIG. 1 to communicate with additional components consistent with a particular application. For example, if the device 100 is a portable electronic device such as a cell phone, then a wireless network interface, random access memory (RAM), digital-to-analog and analog-to-digital converters, amplifiers, keypad input, and so forth will be provided. Likewise, if the device 100 is a personal data assistant (PDA), various hardware consistent with a PDA will be included in the device 100.

The present invention could be implemented in any device capable of capturing images in a digital format. Examples of such devices include digital cameras, digital video recorders, and other electronic devices incorporating digital cameras and digital video recorders such as mobile phones and portable computers. The ability to capture images is not required and the claimed invention can also be implemented as a post processing technique in devices capable of accessing and displaying images stored in a digital format. Examples of portable electronic devices that could benefit from implementation of the claimed invention include, portable gaming devices, portable digital audio players, portable video systems, televisions and handheld computing devices. It will be understood that FIG. 1 is not intended to be limiting, but rather to present those components directly related to novel aspects of the device.

The processor 102 performs digital processing operations and communicates with the MGE 106. The processor 102 is an integrated circuit capable of executing instructions retrieved from the memory 108. These instructions provide the device 100 with functionality when executed on the processor 102. The processor 102 may also be a digital signal processor (DSP) or other processing device.

The memory 108 may be random-access memory or non-volatile memory. The memory 108 may be non-removable memory such as embedded flash memory or other EEPROM, or magnetic media. Alternatively, the memory 108 may take the form of a removable memory card such as ones widely available and sold under such trade names such as “micro SD”, “miniSD”, “SD Card”, “Compact Flash”, and “Memory Stick.” The memory 108 may also be any other type of machine-readable removable or non-removable media. Additionally, the memory 108 may be remote from the device 100. For example, the memory 108 may be connected to the device 100 via a communications port (not shown), where a BLUETOOTH® interface or an IEEE 802.11 interface, commonly referred to as “Wi-Fi,” is included. Such an interface may connect the device 100 with a host (not shown) for transmitting data to and from the host. If the device 100 is a communications device such as a cell phone, the device 100 may include a wireless communications link to a carrier, which may then store data on machine-readable media as a service to customers, or transmit data to another cell phone or email address. Furthermore, the memory 108 may be a combination of memories. For example, it may include both a removable memory for storing media files such as music, video or image data, and a non-removable memory for storing data such as software executed by the processor 102.

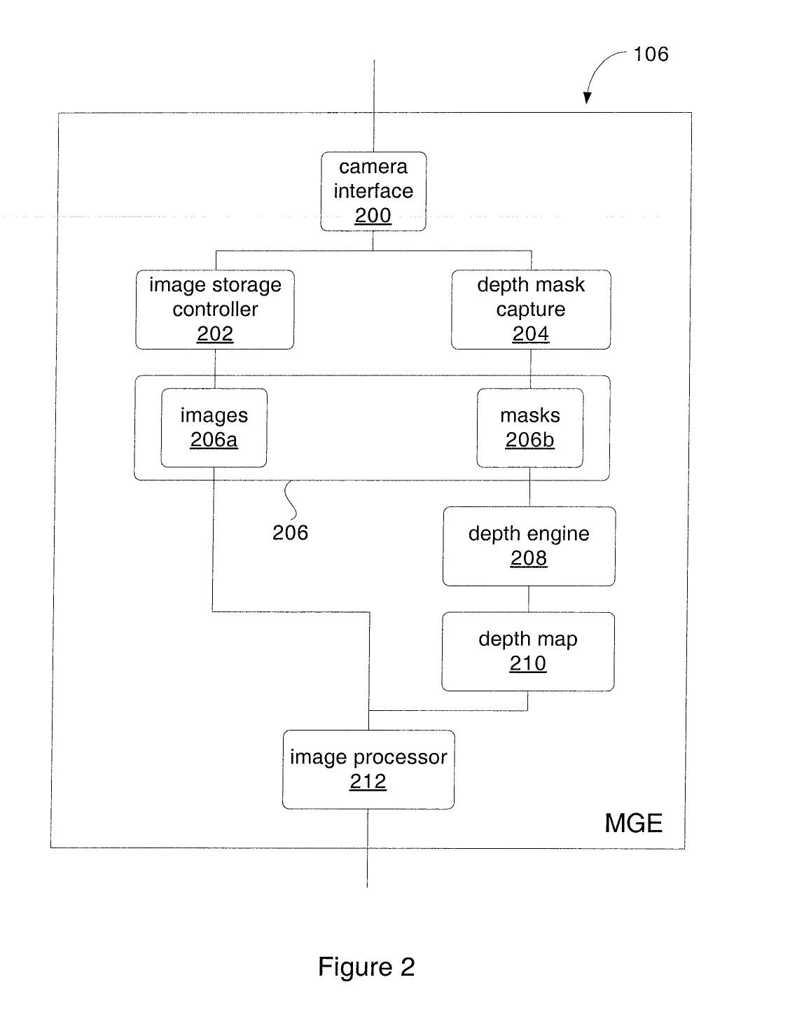

FIG. 2 is a simplified schematic diagram illustrating a high level architecture for the graphics controller 106 in accordance with one embodiment of the present invention. The graphics controller 106 includes a camera interface 200. The camera interface 200 can include hardware and software capable of capturing and manipulating data associated with digital images. In one embodiment, when a user takes a picture, the camera interface captures two pictures in rapid succession from a single image capture device. Note that the reference to a single image capture device should not be construed to limit the scope of this disclosure to an image capture device capable of capturing single images, or still images. Some embodiments can use successive still images captured through one lens, while other embodiments can use successive video frames captured through one lens. Reference to a single image capture device is intended to clarify that the image capture device, whether a video capture device or still camera, utilizes one lens rather than a plurality of lenses. By comparing pixel data of the two successive images, elements of the graphics controller 106 are able to determine depth data for elements captures in the first image. In addition to capturing digital images, the camera interface 200 can include hardware and software that can be used to process/prepare digital image data for subsequent modules of the graphics controller 106.

Connected to the camera interface 200 is an image storage controller 202 and a depth mask capture module 204. The image storage controller 202 can be used to store image data for the two successive images in a memory 206. The depth mask capture module 204 can include logic configured to compare pixel values in the two successive images. In one embodiment, the depth mask capture module 204 can perform pixel-by-pixel comparison of the two successive images to determine pixel shifts of elements within the two successive images. The pixel-by-pixel comparison can also be used to determine edges of elements within the image data based on pixel data such as luminosity. By detecting identical pixel luminosity changes between the two successive images, the depth capture mask can determine the pixel shifts between the two successive images. Based on the pixel shifts between the two successive images, the depth mask capture module 204 can include additional logic capable of creating a depth mask. In one embodiment, the depth mask can be defined as the pixel shifts of edges of the same elements within the two successive images. In other embodiments, rather than a pixel-by-pixel comparison, the depth mask capture module can examine predetermined regions of the image to determine pixel shifts between elements within the two successive images. The depth mask capture module 204 can save the depth mask to the memory 206. As shown in FIG. 2, the memory 206 is connected to both the image storage controller 202 and the depth mask capture module 204. This embodiment allows memory 206 to store images 206a from the image storage controller 202 along with depth masks 206b from the depth mask capture module 204. In other embodiments, images 206a and masks 206b can be store in separate and distinct memories.

In one embodiment, a depth engine 208 is connected to the memory 206. The depth engine 208 contains logic that can utilize the depth mask to output a depth map 210. The depth engine 208 inputs the depth mask to determine relative depth of elements within the two successive images. The relative depth of elements within the two successive images can be determined because elements closer to the camera will have larger pixel shifts than elements further from the camera. Based on the relative pixel shifts defined in the depth mask, the depth engine 208 can define various depth planes. Various embodiments can include pixel shift threshold values that can assist in defining depth planes. For example, depth planes can be defined to include a foreground and a background. In one embodiment, the depth engine 208 calculates a depth value for each pixel of the first image, and the depth map 210 is a compilation of the depth values for every pixel in the first image.

An image processor 212 can input the first image stored as part of images 206a and the depth map 210 and output an image for display or save the first image along with the depth map to a memory. In order to efficiently store the depth map 210 data, the image processor 212 can include logic for compressing or encoding the depth map 210. Additionally, the image processor 212 can include logic to save the depth map 210 as header information in a variety of commonly used graphic file formats. For example, the image processor 212 can add the depth map 210 as header information to image data in formats such as Joint Photographic Experts Group (JPEG), Graphics Interchange Format (GIF), Tagged Image File Format (TIFF), or even raw image data. The previously listed type of image data is not intended to be limiting but rather exemplary of different formats capable of being written by the image processor 212. One skilled in the art should recognize that the image processor 212 could be configured to output alternate image data formats that also include a depth map 210.

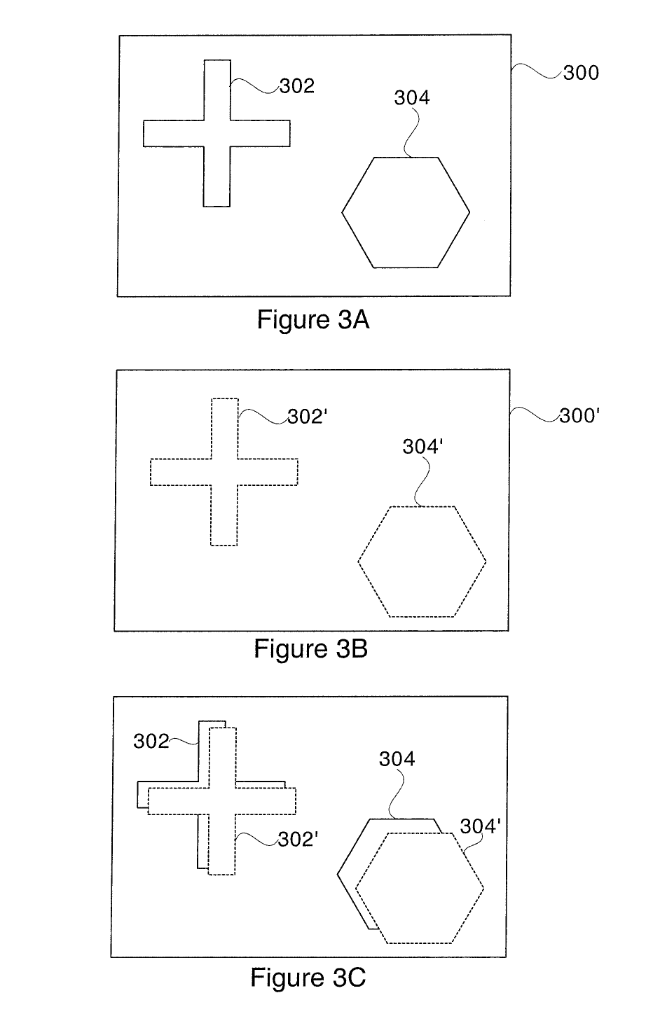

FIG. 3A illustrates a first image 300 captured using an MGE in accordance with one embodiment of the present invention. Within the first image 300 is an image element 302 and an image element 304. FIG. 3B illustrates a second image 300′ that was also captured using an MGE in accordance with one embodiment of the present invention. In accordance with one embodiment of the present invention, the second image 300′ was taken momentarily after the first image 300 using a hand held camera not mounted to a tripod or other stabilizing device. As the human hand is prone to movement, the second image 300′ is slightly shifted and the image elements 302′ and 304′ are not in the same location as image elements 302 and 304. The shift of image elements between the first image and second image can be detected and used to create the previously discussed depth map.

FIG. 3C illustrates the shift of the image elements by overlying the second image over the first image in accordance with one embodiment of the present invention. As previously discussed, image elements that are closer to the camera will have larger pixel shifts relative to image elements that are further from the camera. Thus, as illustrated in FIG. 3C, the shift between image elements 302 and 302′ is less than the shift between image elements 304 and 304′. This relative shift can be used to create a depth map based on the relative depth of image elements.

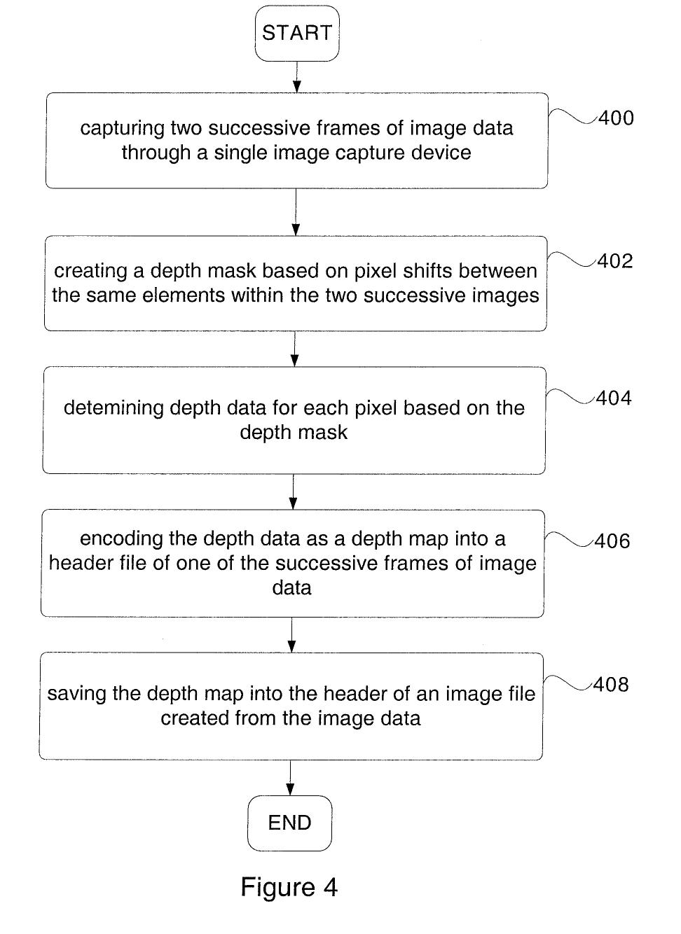

FIG. 4 is an exemplary flow chart of a procedure to encode a depth map in accordance with one embodiment of the present invention. After executing a START operation, the procedure executes operation 400 where two successive frames of image data are captured through a single image capture device. The second frame of image data of the two successive frames is captured in rapid succession after the first image of image data.

In operation 402, a depth mask is created based from the two successive frames of image data. Pixel-by-pixel comparison of the two successive frames can be used to create the depth mask that records relative shifts of pixels of the same elements between the two successive frames. In one embodiment, the depth mask represents the quantitative pixel shifts for elements within the two successive frames.

In operation 404, the depth mask is used to process data in order to generate a depth map. The depth map contains a depth value for each pixel in the first image. The depth values can be determined based on the depth mask created in operation 402. As elements closer to the camera will have relatively larger pixel shifts compared to elements further from the camera, the depth mask can be used to determine relative depth of elements within the two successive images. The relative depth can then be used to determine the depth value for each pixel.

Operation 406 encodes the depth map to a header file that is saved with the image data. Various embodiments can include compressing the depth map to minimize memory allocation. Other embodiments can encode the depth map to the first image while still other embodiments can encode the depth map to the second image. Operation 408 saves the depth map to the header of the image data. As previously discussed, the image data can be saved in a variety of different image formats including, but not limited to JPEG, GIF, TIFF and raw image data.

It will be apparent to one skilled in the art that the functionality described herein may be synthesized into firmware through a suitable hardware description language (HDL). For example, the HDL, e.g., VERILOG, may be employed to synthesize the firmware and the layout of the logic gates for providing the necessary functionality described herein to provide a hardware implementation of the depth mapping techniques and associated functionalities.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A computer implemented method of calculating and encoding depth data from captured image data, comprising:
capturing two successive frames of image data through a single image capture device;
determining differences between a first frame of image data and a second frame of the image data;
calculating a depth map by comparing pixel data of the first frame of the image data to the second frame of the image data; and
encoding the depth map into a header of the first frame of image data.

2. The computer implemented method as in claim 1, further comprising generating a depth mask, wherein the differences between the first frame of image data and the second frame of image data are used to generate the depth mask.

3. The computer implemented method as in claim 1, further comprising identifying a plurality of depth planes, the depth planes based on changes in corresponding pixel data between the first frame of image data and the second frame of image data.

4. The computer implemented method as in claim 2, wherein the depth mask defines a plurality of depth planes.

5. The computer implemented method as in claim 2, wherein the depth mask is generated by comparing relative changes in pixel data for elements within the first frame of image data and corresponding elements within the second frame of image data.

6. The computer implemented method as in claim 1, wherein the differences between the first frame of image data and the second frame of image data are defined by pixel shifts of elements within the captured image data.

7. The computer implemented method as in claim 1, wherein the depth map is saved as a header to an image data file.

8. An image capture device configured to generate a depth map from captured image data comprising;
a camera interface;
an image storage controller interfaced with the camera interface, the image storage controller configured to store two successive frames of image data from the camera interface;
a depth mask capture module configured to create a depth mask based on differences between two successive frames of image data; and
a depth engine configured to process the depth mask to generate a depth map identifying a depth plane for elements in the captured image.

9. The image capture device as in claim 8, wherein the depth mask capture module includes logic configured to detect edges of elements within the image data based on the comparison of pixel data from corresponding locations between the two successive frames of image data.

10. The image capture device as in claim 8, wherein the depth mask capture module includes logic configured to compare corresponding pixel data between the two successive frames of image data.

11. The image capture device as in claim 10, wherein the logic that compares pixel data between the two successive frames of image data detects for relative pixel shifts of elements within the image data.

12. The image capture device as in claim 11, wherein corresponding pixel shifts above a threshold value are indicative of elements that are close to the camera interface.

13. The image capture device as in claim 11, wherein relatively smaller pixel shifts are indicative of elements that are further from the camera interface.

14. The image capture device as in claim 8, wherein the depth mask capture module outputs the depth mask, the depth mask includes multiple depth planes of elements within the image data.

15. The image capture device as in claim 8, wherein the depth engine includes logic configured to place elements in the captured image on depth planes based on the relative pixel shifts between the two successive frames of image data.

16. The image capture device as in claim 8, wherein the image data is manipulated in a post process procedure configured to apply the depth data so depth data is incorporated into displayed image data.

17. The image capture device as in claim 8, further comprising:
a memory configured to store the image data that includes the depth data.

18. The image capture device as in claim 17, wherein the image data is stored as compressed or uncompressed image data.

19. The image capture device as in claim 17, wherein the image data is stored in a header of the stored image data.
